(19) United States
(12) Patent Application Publication
(10) Pub. No.: US 2026/0087720 A1
(43) Pub. Date: Mar. 26, 2026

(54) GENERATION OF ROUGHNESS MAPS FOR THREE-DIMENSIONAL (3D) OBJECTS

(71) Applicants: SONY GROUP CORPORATION, TOKYO (JP); SONY CORPORATION OF AMERICA, NEW YORK, NY (US)

(72) Inventors: CHEN FU, SAN JOSE, CA (US); MOHAMMAD GHARAVI ALKHANSARI, SAN JOSE, CA (US)

(21) Appl. No.: 18/895,014

(22) Filed: Sep. 24, 2024

(51) Int. Cl. G06T 15/04; G06T 7/33; G06T 15/50; G06T 17/20

(52) U.S. Cl. CPC G06T 15/04; G06T 7/33; G06T 15/506; G06T 17/20; G06T 2200/08; G06T 2207/10152

(57) ABSTRACT

An electronic device and method for generation of roughness maps for three-dimensional (3D) objects is disclosed. The electronic device captures a set of images of an object illuminated by a set of lighting patterns of a set of image light sources. The electronic device interleaves the set of polarized OLAT frames on the set of images based on the set of lighting patterns. The electronic device executes a pixel-level inter-frame registration on the set of images, based on the interleaved set of polarized OLAT frames and generates a 3D mesh of the object based on the set of images. Further, the electronic device generates a set of specular maps of the object in a UV texture space, based on the 3D mesh and generates a roughness map associated with the object in the UV texture space, based on the set of specular maps of the object.

### CROSS-REFERENCE TO RELATED APPLICATIONS/INCORPORATION BY REFERENCE

None

### FIELD

Various embodiments of the disclosure relate to three-dimensional (3D) object modeling. More specifically, various embodiments of the disclosure relate to an electronic device and method for generation of roughness maps for 3D objects.

### BACKGROUND

Advancements in the field of three-dimensional (3D) computer graphics have provided the ability to create 3D models and visualize real objects in a 3D computer graphics environment. A 3D model is a static 3D mesh that resembles the shape of a particular object. Typically, such a 3D model is manually designed by computer graphics artists, commonly known as modelers, by use of a modeling software application. Such a 3D model may not be used in the same way in animation, or various virtual reality systems or applications. Roughness mapping is a typical method to define texture details to be applied on the 3D model to texture the 3D model. Creating realistic 3D models and high-fidelity texture/reflectance maps have been a difficult problem in computer graphics and computer vision. With increasing applications in areas of virtual reality, 3D human avatar, gaming, and virtual simulation, generation of accurate and high-fidelity texture or reflectance maps to impart photorealism to a 3D model has become increasingly critical.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for generation of roughness maps for three-dimensional (3D) objects is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for generation of roughness maps for three-dimensional (3D) objects, in accordance with an embodiment of the disclosure.

FIG. 2 is a block diagram that illustrates an exemplary electronic device of FIG. 1, in accordance with an embodiment of the disclosure.

FIGS. 3A and 3B are collectively diagrams that illustrates an exemplary processing pipeline for generation of roughness maps, in accordance with an embodiment of the disclosure.

FIG. 4 is a diagram that illustrates an exemplary scenario for capture of one-light-at-a-time (OLAT) frames, in accordance with an embodiment of the disclosure.

FIG. 5 is a diagram that illustrates an exemplary scenario for interleaving of set of polarized OLAT frames and for pixel-level inter-frame registration, in accordance with an embodiment of the disclosure.

FIG. 6 is a diagram that illustrates an exemplary scenario for generation of a roughness map, in accordance with an embodiment of the disclosure.

FIG. 7 is a diagram that illustrates a flowchart of an exemplary method for generation of roughness maps for 3D objects, in accordance with an embodiment of the disclosure.

### DETAILED DESCRIPTION

The following described implementation may be found in the electronic device and method for generation of roughness maps for 3D objects. Exemplary aspects of the disclosure may provide an electronic device (for example, a server, a desktop, a laptop, or a personal computer) that may execute operations to generate roughness maps for 3D objects. The electronic device may capture, by use of a plurality of image-capture devices, a set of images of an object that is illuminated by a set of lighting patterns associated with a set of image light sources. The set of images may include a set of polarized one-light-at-a-time (OLAT) frames that are captured from a plurality of viewpoints of the object. The electronic device may interleave a set of polarized OLAT frames on the captured set of images based on the set of lighting patterns. The electronic device may execute a pixel-level inter-frame registration on the captured set of images, based on the interleaved set of polarized OLAT frames. The electronic device may generate a three-dimensional (3D) mesh of the object based on the captured set of images. The electronic device may generate a set of specular maps of the object in a UV texture space, based on the generated 3D mesh. The electronic device may generate a roughness map associated with the object in the UV texture space, based on the generated set of specular maps of the object.

Typically, a 3D model may be manually designed by computer graphics artists, commonly known as modelers, by use of a modeling software application. Such a 3D model may not be used in the same way in animation, or various virtual reality systems or applications and texture mapping may be used to define texture details to be applied on the 3D model to texture the 3D object. Creating a realistic model and a roughness map has been a difficult problem in the fields of computer graphics and computer vision. Also, estimation of full-head skin reflectance may be key to generate relightable 3D head models for photo-realistic game and movie creation. In order to address the requirements, the present disclosure introduces a method for generation of high quality and high-resolution skin roughness maps, for objects such as 3D head scans by use of polarized spherical gradient lighting patterns. The present disclosure further introduces a robust specular separation method that allows cameras to be positioned further from a center of the light cage. The present disclosure further introduces operations to generate a specular map to match the unpolarized scan results and a pipeline to generate the roughness map. The present disclosure further introduces a pixel-level inter-frame registration based on the interleaved set of polarized OLAT frames between a gradient lighting pattern.

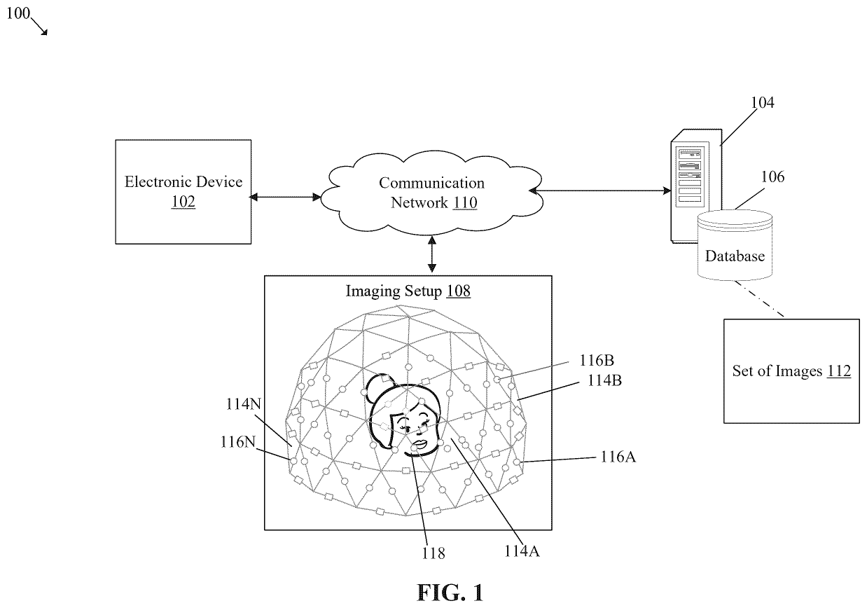

FIG. 1 is a block diagram that illustrates an exemplary network environment for generation of roughness maps for three-dimensional (3D) objects, in accordance with an embodiment of the disclosure. With reference to FIG. 1, there is shown a network environment 100. The network environment 100 may include an electronic device 102, a server 104, a database 106, an imaging setup 108, and a communication network 110. The database 106 may include a set of images 112. The imaging setup 108 may include a first structure 114A, a second structure 114B, . . . and an Nth structure 114N. In FIG. 1, there is further shown a plurality of image-capture devices 116 that may be installed on a 3D cage structure that includes the first structure 114A, the second structure 114B, and the Nth structure 114N. The plurality of image-capture devices 116 may include, for example, a first image-capture device 116A, a second image-capture device 116B, . . . and an Nth image-capture device 116N. The electronic device 102 and the server 104 may be communicatively coupled to one another, via the communication network 110. In FIG. 1, there is further shown an object (e.g., an actor 118).

The “N” structures and “N” image-capture devices shown in FIG. 1 are for exemplary purposes. The 3D cage structure may include two or more than “N” structures and the plurality of image-capture devices 116 may include two or more than “N” image-capture devices, without departure from the scope of the disclosure.

The electronic device 102 may include suitable logic, circuitry, interfaces, and/or code that may be configured to capture, by use of the plurality of image-capture devices 116, the set of images 112 of an object (such as, the actor 118) that may be illuminated by a set of lighting patterns associated with a set of image light sources. The set of images 112 may include a set of polarized one-light-at-a-time (OLAT) frames that are captured from a plurality of viewpoints of the object. The electronic device 102 may interleave the set of polarized OLAT frames on the captured set of images 112 based on the set of lighting patterns. The electronic device 102 may execute a pixel-level inter-frame registration on the captured set of images 112, based on the interleaved set of polarized OLAT frames. The generate a three-dimensional (3D) mesh of the object based on the captured set of images 112. Further, the electronic device 102 may generate a set of specular maps of the object in a UV texture space, based on the generated 3D mesh. Furthermore, the electronic device 102 may generate a roughness map associated with the object in the UV texture space, based on the generated set of specular maps of the object. Examples of the electronic device 102 may include, but are not limited to, a computing device, a smartphone, a cellular phone, a mobile phone, a gaming device, a mainframe machine, a server, a computer workstation, and/or a consumer electronic (CE) device.

The server 104 may include suitable logic, circuitry, and interfaces, and/or code that may be configured to execute operations, such as data/file storage, 3D rendering, or 3D reconstruction operations (such as a photogrammetric reconstruction operation). In one or more embodiments, the server 104 may store the set of images 112 and may execute at least one operation associated with the electronic device 102. The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the set of images 112 or metadata associated with the set of images 112. For example, the metadata may include an identifier of an image-capture device that captures an image, a lighting pattern used at the time of capture, or an identifier of a viewpoint from where the image is captured, or an index value to indicate a position of the image within the set of images 112. The database 106 may be stored or cached on a device, such as a server (e.g., the server 104) or the electronic device 102. The device storing the database 106 may be configured to receive a query for the set of images 112 or the metadata. In response, the device that stores the database 106 may retrieve and provide the set of images 112 or the metadata to the electronic device 102.

In some embodiments, the database 106 may be hosted on a plurality of servers stored at same or different locations. The operations of the database 106 may be executed using hardware, including a processor, a microprocessor (e.g., to perform or control performance of one or more operations), a field-programmable gate array (FPGA), or an application-specific integrated circuit (ASIC). In some other instances, the database 106 may be implemented using software.

The imaging setup 108 may correspond to a 3D cage structure onto which the plurality of image-capture devices 116 may be disposed and oriented to scan the object inside the 3D cage structure from a plurality of viewpoints. The imaging setup 108 may include the plurality of structures 114, each of which may be connected at certain locations to form a cage-like structure (e.g., a 3D dome structure as shown in FIG. 1). The present disclosure may not be limited to any particular shape of the 3D cage structure. In some embodiments, the shape of the cage-like structure may be cylindrical, cuboidal, or any arbitrary share, depending on the requirement of the volumetric studio/capture. In some embodiments, each of the plurality of structures 114 may have the same or different dimensions depending on the requirement of the volumetric studio/capture. In addition to the plurality of image-capture devices 116, a plurality of audio capture devices (not shown), and/or a plurality of light sources (not shown) may be disposed at certain locations on the plurality of structures 114 to form the imaging setup 108.

Each of the plurality of image-capture devices 116 may include suitable logic, circuitry, and interfaces that may be configured to capture the set of images 112 of the actor 118. Each of the plurality of image-capture devices 116 may be further configured to transmit the set of images 112 to the database 106, via the server 104, for storage on the database 106. Each of the plurality of image-capture devices 116 may further transmit the set of images 112 to the electronic device 102 for generation of a roughness map associated with the actor 118. Examples of the plurality of image-capture devices 116 may include, but are not limited to, an image sensor, a wide-angle camera, an action camera, a closed-circuit television (CCTV) camera, a camcorder, a camera with an integrated depth sensor, a cinematic camera, Digital Single-Lens Reflex (DSLR) camera, a Digital Single-Lens Mirrorless (DSLM) camera, a digital camera, camera phones, a time-of-flight camera (ToF camera), a night-vision camera, a 360-degree camera, and/or other image-capture devices.

By way of example, and not limitation, each structure may include a mount to hold at least one image-capture device (represented by a circle in FIG. 1) and at least one processing device. As shown in FIG. 1, each structure (e.g., a truss) may include a frame of a particular material (e.g., metal, plastic, or fiber) to hold at least one of an image-capture device, a processing device, an audio-capture device, and a light source (e.g., a flash). Different 3D structures of same or different shapes can be connected to form the imaging setup 108. In an embodiment, the processing device may be the electronic device 102.

In some embodiments, a movable imaging setup may be created. In such an implementation, each of the plurality of structures 114 of the movable imaging setup may correspond to an unmanned aerial vehicle (UAV) and the plurality of image-capture devices 116, the plurality of light sources, and/or other devices may be mounted on a plurality of unmanned aerial vehicles (UAVs).

The communication network 110 may include a communication medium through which the electronic device 102 and the server 104 may communicate with one another. The communication network 110 may be one of a wired connection or a wireless connection. Examples of the communication network 110 may include, but are not limited to, the Internet, a cloud network, Cellular or Wireless Mobile Network (such as Long-Term Evolution and 5th Generation (5G) New Radio (NR)), a satellite network (e.g., a network of a set of low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the electronic device 102 may be configured to capture, by use of the plurality of image-capture devices 116, the set of images 112 of the object (such as, the head of the actor 118) that is illuminated by the set of lighting patterns associated with the set of image light sources. The set of images 112 includes a set of polarized one-light-at-a-time (OLAT) frames that are captured from the plurality of viewpoints of the object. By way of example, and not limitation, the set of lighting patterns may include one or more of a cross-polarized omni-directional lighting pattern, gradient lighting patterns, and polarized lighting patterns, including a cross-polarized lighting pattern and a parallel-polarized lighting pattern.

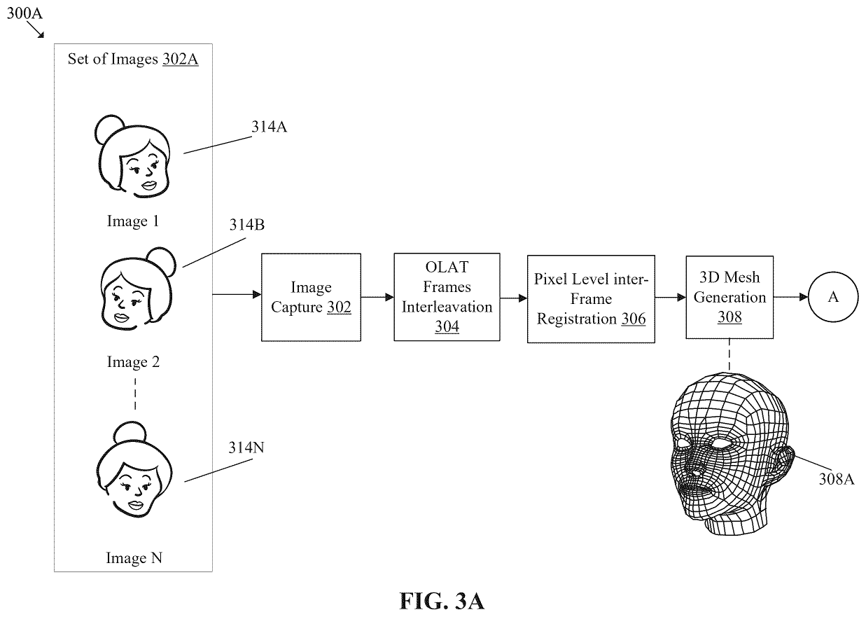

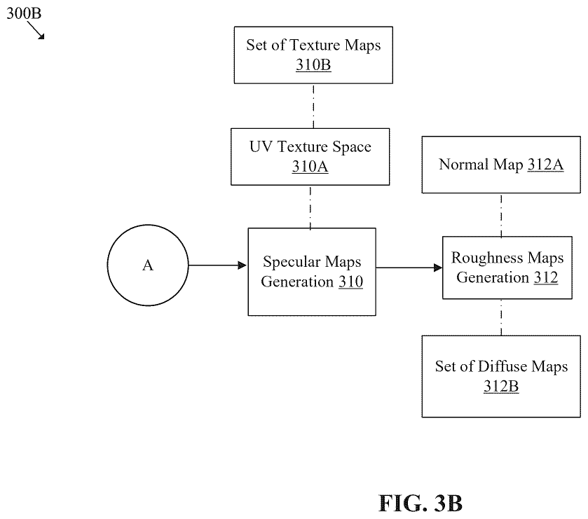

In an exemplary embodiment, the object may be a human head (with face) and the set of images 112 may be captured from the imaging setup 108 that may operate as a polarization-based light cage. The object may be scanned via one or more cameras of the imaging setup 108 from a plurality of viewpoints to obtain the set of images 112. In order to obtain high-fidelity reflectance and normal/height maps for object, the object may be required to be exposed to different lighting patterns at a time of capture of images of the object from different viewpoints. Details related to the acquisition of a set of images are further provided, for example, in FIG. 3A.

In some instances, when the object may be scanned to capture the set of images 112. In such a case, the object may be required to stay still throughout the scan phase. However, there may be some unavoidable movement (e.g., head movement) of the object. Actual between-frame movement may be assumed to be small. The rigid motion may be estimated and removed based on a patch match between images or frames to obtain a set of motion-corrected images. Details of such methods that may generate the set of motion-correction images have been omitted from the disclosure for the sake of brevity.

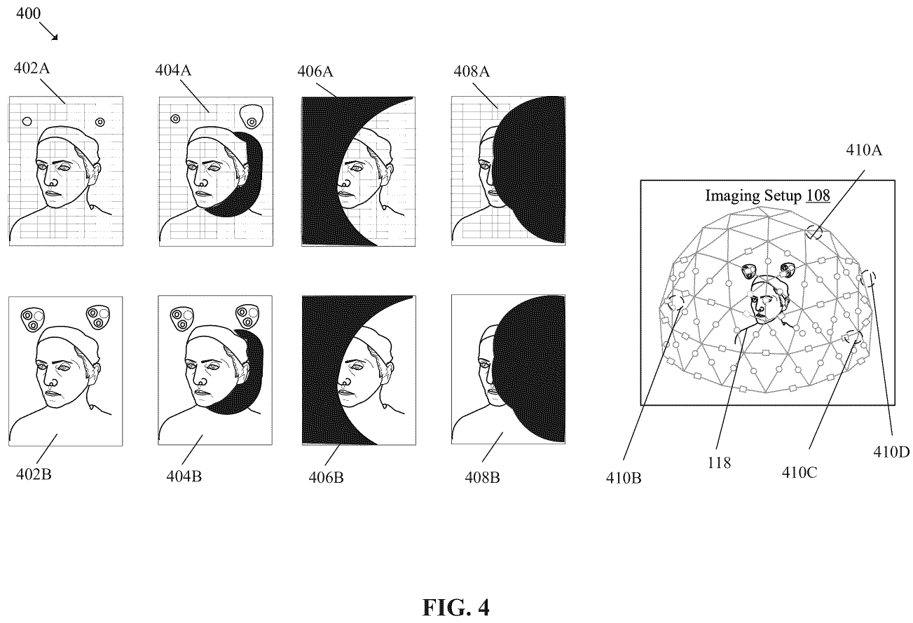

The electronic device 102 may be configured to interleave the set of polarized OLAT frames on the captured set of images 112 based on the set of lighting patterns. By way of example, and not limited, the set of polarized OLAT frames may be interleaved on the set of images 112 by use of an estimated optical flow. The optical flow results may be interpolated based on a combination of a set of pixels matches to form initial sparse motion vectors. Details of such methods have been omitted from the disclosure for the sake of brevity. The polarized OLAT frames may be obtained based on the cross-polarized lighting pattern and parallel-polarized lighting pattern. The polarized OLAT frames may be captured based on light from a single-direction at a time. The polarized OLAT frames may be captured to sample the specular reflection space. An example of OLAT frames capture is provided, for example, in FIG. 3A and FIG. 4.

The electronic device 102 may be configured to execute a pixel-level inter-frame registration on the captured set of images 112, based on the interleaved set of polarized OLAT frames. By way of example, and not limited, the pixel-level inter-frame registration may be executed by use of a dense optical flow, which may require a computation of an optical flow vector for each pixel in each frame or set of images 112. The dense optical flow method may match each point pixel on the image of the set of images 112 to calculate an offset. Further, the method may provide a higher accuracy to matched moving objects. However, the method is more computationally intensive due to a high level of detail the method provides. The dense optical flow includes at least two images to estimate the apparent motion of each pixel in each image of the set of images 112. For example, the dense optical flow may be computed by use of two consecutive images of the set of images 112. Details of such methods have been omitted from the disclosure for the sake of brevity. The polarized OLAT frames may be interleaved between the captured set of images 112. An example pixel-level inter-frame registration is provided, for example, in FIG. 3A and FIG. 4.

The electronic device 102 may be configured to generate a 3D mesh (For example, the 3D mesh as shown at 308A in FIG. 3A) of the object based on the captured set of images 112. By way of example, and not limitation, the 3D mesh may be generated from the set of images 112 using a photogrammetry-based method (such as structure from motion (SfM)), a method which requires stereoscopic images, or a method which requires monocular cues (such as shape from shading (SfS), photometric stereo, or shape from texture (SfT)). Details of such methods have been omitted from the disclosure for the sake of brevity. The 3D mesh may be an untextured mesh that resembles the 3D shape of the object. The 3D mesh may use polygons to define the shape or the geometry of the object. An example 3D mesh for a human head is provided, for example, in FIG. 3A.

The electronic device 102 may be configured to generate a set of specular maps (for example, the set of specular maps 310 in FIG. 3B) of the object in the UV texture space (for example, the UV texture space 310A in FIG. 3B), based on the generated 3D mesh. The set of specular maps may be based on the separation of specular component from the UV texture space associated with the set of texture maps. The set of specular maps may depict shininess of a surface of the object and a diffuse reflectance map may depict reflection from the object without any atmospheric reflection. Details related to the set of specular maps are provided, for example, in FIG. 3B.

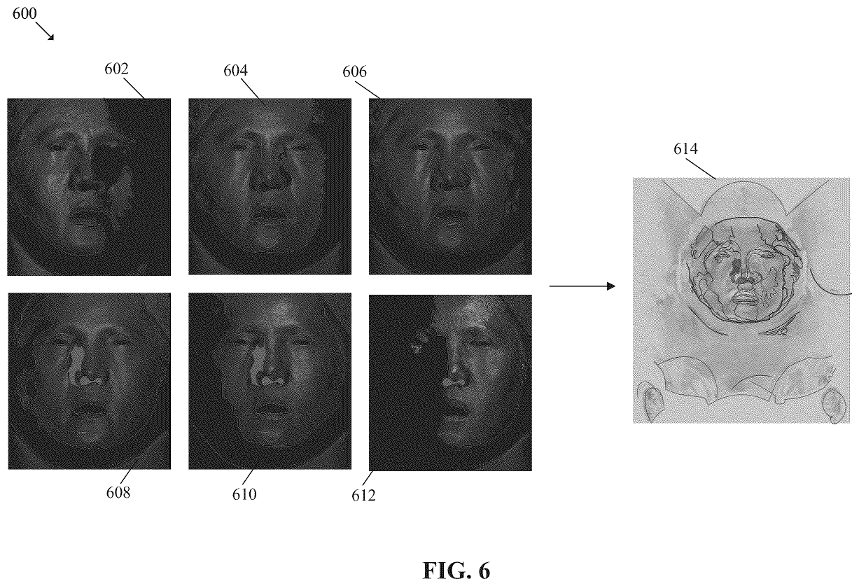

The electronic device 102 may further generate the roughness map (for example, the roughness map 614 in FIG. 6) associated with the object in the UV texture space, based on the generated set of specular maps of the object. The roughness map may be generated based on the set of specular maps, a set of texture maps, a set of diffuse maps, and a normal map associated with the captured set of images 112 of the object (e.g., the head of the actor 118). Details related to the roughness map are provided, for example, in FIG. 3B.

Typically, a 3D model may be manually designed by computer graphics artists, commonly known as modelers, by use of a modeling software application. Such a 3D model may not be used in the same way in animation, or various virtual reality systems or applications and texture mapping may be used for defining texture details to be applied on the 3D model to texture the 3D object. Creating a realistic model and a roughness map has been a difficult problem in the fields of computer graphics and computer vision. Also, estimation of full-head skin reflectance is key to generating relightable 3D head models for photo-realistic game and movie creation. In order to address the requirements, the present disclosure introduces a method to generate high quality and high-resolution skin roughness maps, for objects such as 3D head scans using polarized spherical gradient lighting patterns. The present disclosure further introduces a robust specular separation method that allows cameras to be positioned further from the equator of the light cage. The present disclosure further introduces operations to generate a specular map to match the unpolarized scanning results and a pipeline to generate the roughness map. The present disclosure further introduces a pixel-level inter-frame registration based on interleaved set of polarized OLAT frames of the polarized OLAT frames between the gradient lighting patterns.

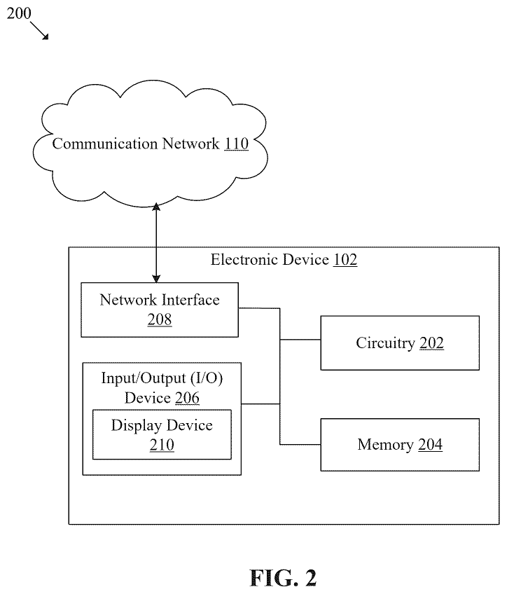

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown a block diagram 200 of the electronic device 102. The electronic device 102 may include circuitry 202, memory 204, an input/output (I/O) device 206, and a network interface 208. The I/O device 206 may include a display device 210.

The circuitry 202 may include suitable logic, circuitry, and/or interfaces that may be configured to execute program instructions associated with different operations to be executed by the electronic device 102. For example, the operations may include capturing of images, interleaving of OLAT frames, execution of pixel-level inter-frame registration, three-dimensional (3D) mesh generation, specular map generation, and roughness map generation. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The memory 204 may be configured to store the set of images 112. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the I/O device 206 may receive a first user input indicative of the selection of the set of images 112. In another example, the I/O device 206 may receive a second user input including an instruction to capture the set of images 112 of the actor 118. The I/O device 206 may be further configured to display the set of images 112 and/or the 3D mesh. The I/O device 206 may include the display device 210. Examples of the I/O device 206 may include, but are not limited to, a touch screen, a keyboard, a display device (e.g., the display device 210), a mouse, a joystick, a microphone, or a speaker.

The network interface 208 may include suitable logic, circuitry, interfaces, and/or code that may be configured to facilitate communication between the electronic device 102 and the server 104, via the communication network 110. The network interface 208 may be implemented by use of various known technologies to support wired or wireless communication of the electronic device 102 with the communication network 110. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display one or more images of the set of images 112 and/or the 3D mesh. The display device 210 may be a touch screen which may enable a user to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for generation of reflectance maps for relightable 3D models are described further, for example, in FIGS. 3A and 3B.

FIGS. 3A and 3B are diagrams that collectively illustrate an exemplary processing pipeline for generation of roughness maps, in accordance with an embodiment of the disclosure. FIGS. 3A and 3B are explained in conjunction with elements from FIG. 1 and FIG. 2. With reference to FIGS. 3A and 3B, there is shown an exemplary processing pipeline 300A and 300B that illustrates exemplary operations from 302 to 312. The exemplary operations 302 to 312 may be executed by any computing system, for example, by the electronic device 102 of FIG. 1 or by the circuitry 202 of FIG. 2. The exemplary processing pipeline 300A and 300B further illustrates a set of images 302A, a 3D mesh 308A, a UV texture space 310A associated with a set of texture maps 310B, a normal map 312A, and a set of diffuse maps 312B. The set of images 302A may include N number of images such as first direction image 314A, second direction image 314B, . . . and Nth direction image 314N of the face or the head of the object. The number of images shown in FIG. 3A is presented merely as an example and such an example should not be construed to limit the scope of the disclosure.

With reference to FIG. 3A, at 302, a set of images may be captured. The circuitry 202 may be configured to capture the set of images 302A of the object (for example, the head of the actor 118) that may be illuminated by the set of lighting patterns associated with the set of image light sources. The set of images 302A may include a set of polarized OLAT frames that are captured from a plurality of viewpoints (for example, a first direction image 314A, a second direction image 314B, . . . and a Nth direction image 314N) of the object. Further, the object may be exposed to the set of lighting patterns within a capture duration of the set of Images 302A. The object may be any animate or inanimate object. An example of the object as a human head is shown in FIG. 3A. The plurality of image-capture devices 116 (such as, cameras) may scan the object to capture one or more images from different viewpoints while the object may be exposed to the set of lighting patterns within the capture duration. From each camera view, multiple images of the object may be captured. The electronic device 102 may receive the set of images 112 from the one or more cameras. The set of images 112 may include image(s) with different lighting patterns and viewpoints.

In an embodiment, the object may be a human head and the set of images 302A may be captured from an imaging setup (e.g., the imaging setup 108) that operates as a polarization-based light cage. The light cage may be, for example, a dome-shaped cage structure that may include a number of movable or static lighting devices and one or more image-capture devices placed at different locations on the cage structure. The lighting devices may emit different lighting patterns based on one or more control signals from the electronic device 102 or from a standalone controller device. In case of the polarization-based light cage, the lighting devices may emit polarized light (cross or parallel polarization). The object, i.e., the actor 118, may be seated at a center of the light cage and each image-capture device may capture images of the human head while the human head is exposed to the set of lighting patterns. For example, the object may be an actor and the one or more image-capture devices may capture the set of images 112 of the actor's head (such as, the head of the actor 118) under different lighting patterns.

In an embodiment, the set of polarized OLAT frames may be captured in a condition when the object may be illuminated by one of the lighting patterns associated with one of the light sources of the set of image light sources. The set of polarized OLAT frames may be captured along the light direction of the light source. In an embodiment, the set of lighting patterns for the polarized OLAT frames capture may include a minimum of four lighting directions for 3D coverage. The set of lighting patterns for the set of polarized OLAT frames may include a cross-polarized lighting pattern and a parallel-polarized lighting pattern. To capture the set of polarized OLAT frames, one of the light sources (such as an LED) and lens of the capture devices may be configured with a polarizer. For example, to capture 8 OLAT frames, following equation (1) may be used:

$$2 polarizations * 4 lighting directions = 8 OLAT frames \qquad ( 1 )$$

Herein, 2 polarization may include the cross-polarized lighting pattern and the parallel-polarized lighting pattern.

In an embodiment, the set of lighting patterns may include one or more of a cross-polarized omni-directional lighting pattern, gradient lighting patterns, and polarized lighting patterns, including the cross-polarized lighting pattern and the parallel-polarized lighting pattern. In an embodiment, the set of lighting patterns may include a minimal of eleven polarized gradient lighting patterns, including cross-polarized lighting pattern and parallel polarization lighting pattern under three axis, i.e., ‘X’ axis, ‘Y’ axis, and ‘Z’ axis. In some instances, it may be preferable to use nine gradient lighting patterns may provide better quality frames than that generated by use a minimal of six or a maximal of twelve, without performing motion correction.

At 304, the set of polarized OLAT frames may be interleaved. The circuitry 202 may be configured to interleave the set of polarized OLAT frames on the captured set of images 112 based on the set of lighting patterns. In an embodiment, the set of polarized OLAT frames may be interleaved between gradient lighting patterns. The gradient lighting patterns may be captured based on a control of a location and an intensity of the set of image lighting sources associated with the object (for example, the head of the actor 118). For example, the method used to capture the gradient lighting patterns may include at least one of a split lighting, a loop lighting, or a Rembrandt lighting. Details of such methods have been omitted from the disclosure for the sake of brevity.

For example, if the circuitry 202 captures eleven images associated gradient lighting patterns and 8 OLAT frames, then the circuitry 202 may interleave 8 OLAT frames on the eleven images associated gradient lighting patterns based on the set of lighting patterns. Herein, the set of polarized OLAT frames may be randomly interleaved on the images of the gradient lighting patterns. For instance, the 8 OLAT frames may be interleaved at the 4^{th} position, 6^{th} position, 8^{th} position, 10^{th} position, 12^{th} position, 14^{th} position, 16^{th} position, 18^{th} position in the position of the captured set of images 112.

At 306, a pixel-level inter-frame registration may be executed. The circuitry 202 may be configured to execute the pixel-level inter-frame registration on the captured set of images 112, based on the interleaved set of polarized OLAT frames. The pixel-level inter-frame registration may be executed by use of a dense optical flow, a method which requires computation of an optical flow vector for each pixel in each frame or set of images 112. The optical flow vector may include horizontal and vertical displacement of each pixel over a time interval. The method may match each point pixel on the image of the set of images 112 to calculate an offset. Further, the method may provide a higher accuracy to match moving objects. However, the method may be more computationally intensive due to the high level of detail that the method provides. The dense optical flow includes at least two images to estimate the apparent motion of each pixel in each image of the set of images 112. In an example, the dense optical flow may be computed by use of two consecutive images of the set of images 112. Details of such methods have been omitted from the disclosure for the sake of brevity.

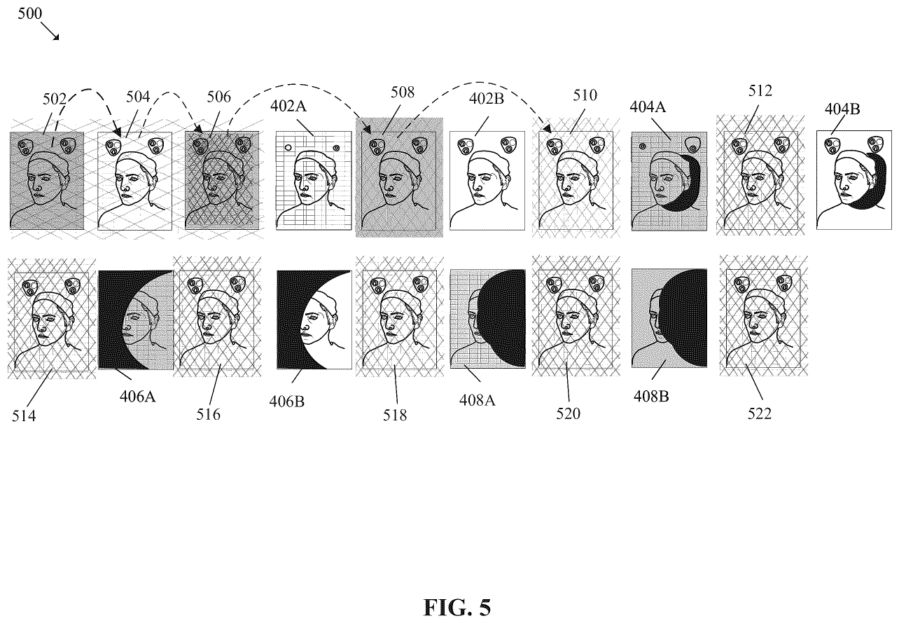

In an embodiment, a plurality of pixels of a set of neighboring inter-frames (for example, neighboring inter-frames shown in FIGS. 5 as 502 and 504, 504 and 506 or 506 and 508) may be registered based on the interleaved set of polarized OLAT frames (for example OLAT frames as shown in FIG. 5 as 402A and 402B) in gradient light patterns (for example inter-frames associated with gradient lighting patterns such as the set of images as shown in FIG. 5 as 502-522). Further, the circuitry 202 may determine a pattern of the registered plurality of pixels based on an interpolation of the set of neighboring inter-frames.

In an embodiment, the object may be an actor's head, whose images may be captured. Head movements may not be avoidable in the duration of capture. Typically, motion may be estimated and removed based on estimation and alignment of 3D positions of markers or coded targets placed on a cap (worn by the actor). However, many studios may prefer to capture images of the actor with hair (i.e., without the cap). In such a situation, coded targets or markers may not be suitable. If it is assumed that the object stays still for at least one second, then actual between-frame movement may be assumed to be miniscule. The motion may be removed by performing patch matching between images to obtain the set of motion-corrected images. The circuitry 202 may be configured to obtain the set of motion-corrected images based on the interleaved set of polarized OLAT frames.

At 308, a 3D mesh may be generated. The circuitry 202 may be configured to generate the 3D mesh 304 of the object based on multi-view image data (e.g., the captured set of images 302A). The 3D mesh 304 may be an untextured base mesh that may be used in operations associated with generation of the texture, reflectance, or normal/height maps of the object. As discussed, the 3D mesh may be generated from the set of images 112 by use of a photogrammetry-based method (such as, structure from motion (SfM)), a method which requires stereoscopic images, or a method which requires monocular cues (such as shape from shading (SfS), photometric stereo, or shape from texture (SfT)). Details of such methods have been omitted from the disclosure for the sake of brevity.

In an embodiment, the circuitry 202 may be configured to determine a sparse feature point between the set of images (for example, inter-frames associated with gradient lighting patterns (such as, the set of images as shown in FIG. 5 as 502-522) from the plurality of viewpoints. Further, the circuitry 202 may be configured to determine a plurality of camera parameters associated with the plurality of image-capture devices 116 and then determine a relationship between each image point of an image of the set of images 112, with each corresponding 3D point associated with the 3D mesh based on the determined plurality of camera parameters. Herein, the relationship may be determined for each viewpoint of the plurality of viewpoints, and the execution of the pixel-level inter-frame registration may be further based on the determined relationship of each image point with each corresponding the 3D point associated with the 3D mesh.

For instance, if the captured set of images 112 may include the set of polarized OLAT frames (for example, the set of polarized OLAT frames as shown in FIG. 4 as 402A-408B) and the set of images 112 associated with gradient lighting patterns. Then, the set of polarized OLAT frames may be interleaved on the set of images 112 associated with gradient lighting patterns, as shown in FIG. 5. Further, the circuitry 202 may be configured to determine the relationship between each image point of the image of the interleaved set of images 112 with each corresponding 3D points associated with the 3D mesh based on determination of the camera parameters associated with plurality of the image-capture devices 116. Furthermore, the circuitry 202 may be configured to execute the pixel-level inter-frame registration on the interleaved set of images 112 based on determination of the sparse feature point between the interleaved set of images 112 and the relationship of each image point with corresponding 3D points.

In an embodiment, the relationship between each image point of an image of the set of images 112, with each corresponding 3D point may be determined to execute pixel-level registration of a multi-view image.

In an embodiment, circuitry 202 may be configured to determine a location of the plurality of image-capture devices 116 and the set of image light sources associated with the set of lighting patterns. Further, the circuitry 202 may determine a coverage of an imaging setup associated with the plurality of image-capture devices 116 and the set of image light sources based on the determined location. Further, the circuitry 202 may determine a light intensity captured in the set of images 112 based on the generated 3D mesh and determined coverage. Further, the circuitry 202 may apply a lighting model on the captured set of images 112 to determine a light intensity of each OLAT frame of the set of polarized OLAT frames and then fine-tune a lighting direction of the set of image light sources. For example, the set of captured image may include the captured set of polarized OLAT frames. Further, the plurality of image-capture devices 116 may include a camera and the set of image light sources may include OLAT LEDs. By way of example, and not limitation, the lighting model may include an Lambertian lighting model, a Phong illumination model, a Blinn-Phong illumination model, or a Smallpt lighting model. Herein, the cameras and the OLAT LEDs may be fixed in the imaging setup (such as, a light cage, e.g., the imaging setup 108). Thus, the location and relative positioning of the OLAT LEDs and the cameras may be determined. Further, the Lambertian lighting model may be applied on the set of polarized OLAT frames to determine the light intensity of each OLAT frame of the set of polarized OLAT frames. Furthermore, the OLAT LEDs may be fine-tuned for a lighting direction.

OLAT frames may be captured from a plurality of viewpoints of the object (e.g., the actor 118) based on OLAT lighting patterns. The OLAT lighting pattern may be estimated based on the location and relative positioning of the cameras and the OLAT LEDs. Details of such methods for application of lighting model have been omitted from the disclosure for the sake of brevity.

With reference to FIG. 3B, at 310, a set of specular maps may be generated. The circuitry 202 may be configured to generate the set of specular maps of the object in the UV texture space 310A (associated with the set of texture maps 310B), based on the generated 3D mesh. The circuitry 202 may be configured to perform a UV mapping for multi-view cross-polarization and parallel polarization images and perform a specular separation in the UV texture space 310A. The generation of the set of specular maps may further be based on a first intensity of parallel polarization lighting pattern and a second intensity of cross-polarization lighting pattern. Thus, the set of specular maps (denoted by lⁱ_{specular}) may be generated based on the parallel polarization lighting pattern and cross-polarization lighting pattern, as given by following equation (2):

$${I}_{Specular}^{i} = ( {I}_{p}^{i} - {I}_{c}^{i} ) / 2 \qquad ( 2 )$$

where lⁱ_{specular} may be the set of specular maps,
Iₚⁱ may be the first intensity of parallel polarization lighting pattern, and
I_{c}ⁱ may be the second intensity of cross-polarization lighting pattern.

Typically, for set of specular maps generation, specular components may be separated directly from input images (e.g., from the second intensity of cross-polarization lighting pattern (It) and the first intensity of parallel polarization lighting pattern (Is)) to generate view dependent specular components for every camera view. The process of generation of specular maps may include an identification and an isolation of specular reflections or highlights from an image or 3D scan. The identification and isolation may be executed to improve an accuracy of shape recovery or to enhance the quality of the 3D scan. Techniques for specular extraction may include adjusting lighting, using polarized filters, and post-processing methods. Details of such methods have been omitted from the disclosure for the sake of brevity.

In an embodiment, the set of texture maps 310B may be generated in the UV space based on the set of motion-corrected images and the 3D mesh. Details of such methods to generate the set of texture maps 310B have been omitted from the disclosure for the sake of brevity.

At 312, a roughness map generation may be executed. The circuitry 202 may be configured to generate the roughness map associated with the object in the UV texture space 310A (associated with the set of texture maps 310B), based on the generated set of specular maps of the object (e.g., the actor 118). The circuitry 202 may be configured to apply a light model on the generated set of specular maps to estimate specular exponent parameters. Alternatively, the roughness map associated with the object may further be generated based on the estimated specular exponent parameters. For example, the electronic device 102 may generate the roughness map based on the application of a Blinn-Phong lighting model to the set of specular maps to estimate the specular exponent parameters. The estimated specular exponent parameters of each image point may be converted to the roughness values. Thus, the roughness map may be generated.

Typically, the specular exponent parameters may be estimated based on an observation of a specular highlight point on the object. The size of the specular highlight point may depend on a value of the specular exponent property of the specular highlight point and the object. The specular exponent can range from 0 to infinity. In the context of Phong's approximation, the specular exponent may not be allowed to be zero. The specular exponent property (for example, shininess factor) may also be considered as an attribute of the material, so different objects may have different specular power values.

In an embodiment, the roughness map may be further generated based on the normal map 312A and the set of diffuse maps 312B. The normal map 312A may be generated based on the conversion of a surface normal vector associated with the captured set of images 112 of the object (such as, the actor 118). The generated normal map 312A may be associated to a surface and may be independent of geometry of the object.

In an embodiment, the set of diffuse maps 312B may be obtained based on the separation of diffuse components from the UV texture space (such as, the UV texture space 310A associated with the set of texture maps 310B). The diffuse reflectance components may be separated from each of the set of texture maps, i.e., the cross-polarized lighting pattern in the UV texture space 310A and the polarized lighting pattern in the UV texture space 310A.

FIG. 4 is a diagram that illustrates an exemplary scenario for capture of one-light-at-a-time (OLAT) frames, in accordance with an embodiment of the disclosure. FIG. 4 is explained in conjunction with elements from FIG. 1, FIG. 2, FIG. 3A, and FIG. 3B. With reference to FIG. 4, there is shown an exemplary scenario 400 that illustrates a set of polarized OLAT frames 402A to 408B obtained by the imaging setup 108 by use of the plurality of image-capture devices 410A to 410D. The exemplary set of polarized OLAT frames 402A to 408B may be obtained by any computing system, for example, by the electronic device 102 of FIG. 1 or by the circuitry 202 of FIG. 2.

In an embodiment, the object may be a human head of an actor (for example, the head of the actor 118) and the set of images 402A-408B may be captured from the imaging setup (e.g., the imaging setup 108 or a light cage) that may operate as a polarization-based light cage. The light cage may be, for example, a dome-shaped cage structure that may include a number of movable or static lighting devices (for example, OLAT LEDs) and four image-capture devices 410A-410D placed at different locations on the cage structure as shown in FIG. 4. The OLAT LEDs may one-directional lighting patterns based on one or more control signals from the electronic device 102 or from a standalone controller device. In case of the polarization-based light cage, the lighting devices may emit polarized light (e.g., based on a cross-polarization or a parallel-polarization). The object, i.e., the actor 118, may be seated at the center of the light cage and each image-capture device 410A-410D may capture images of the human head while the human head may be exposed to the one-directional lighting patterns. Thus, the set of images 112 including the set of polarized OLAT frames 402A-408B may be captured.

It should be noted that the scenario 400 of FIG. 4 is for exemplary purposes and should not be construed to limit the scope of the disclosure.

FIG. 5 is a diagram that illustrates an exemplary scenario for interleaving of set of polarized OLAT frames and for pixel-level inter-frame registration, in accordance with an embodiment of the disclosure. FIG. 5 is explained in conjunction with elements from FIG. 1, FIG. 2, FIG. 3A, FIG. 3B, and FIG. 4. With reference to FIG. 5, there is shown an exemplary scenario 500 that illustrates the set of polarized OLAT frames 402A to 408B interleaved between gradient lighting patterns 502 to 522 associated with the set of images 112. The exemplary set of polarized OLAT frames 402A to 408B may be interleaved by any computing system, for example, by the electronic device 102 of FIG. 1 or by the circuitry 202 of FIG. 2.

In an embedment, the set of polarized OLAT frames 402A to 408B may be interleaved randomly between the gradient lighting patterns 502 to 522. Typically, the set of images 112 in gradient lighting patterns may be captured by use of a combination of 3D mesh and image capture under different lighting conditions. Details of such methods have been omitted from the disclosure for the sake of brevity. Further, the circuitry 202 may be configured to execute the pixel-level inter-frame registration on the captured set of images 112 (such as, OLAT frames or the gradient lighting patterns). In an example, the pixel-level inter-frame registration between the gradient lighting pattern 502 to 522 may be executed by the dense optical flow technique. Further, the registered pixel-level inter-frame may be interpolated to estimate an optical flow for the polarized OLAT frames 402A to 408B. In an embodiment, the pixel-level inter-frame registration may be executed to register each image of the set of images 112.

In an embodiment, the circuitry 202 may be configured to determine a sparse feature point between the set of images 112 from the plurality of viewpoints to determine camera parameters of the plurality of image-capture devices 116. Further, the relationship between each image point of the image (of the set of image) with each corresponding 3D point associated with the 3D mesh may be determined based on the plurality of camera parameters. In an embodiment, the relationship may be determined for each viewpoint of the plurality of the viewpoints and the execution of the pixel-level inter-frame registration may also be based on the relationship of each image with each corresponding 3D points.

In an embodiment, the above mentioned operation may be executed for a number of epochs to register a set of multi-view images. It should be noted that the scenario 500 of FIG. 5 is for exemplary purposes and should not be construed to limit the scope of the disclosure.

FIG. 6 is a diagram that illustrates an exemplary scenario for generation of a roughness map, in accordance with an embodiment of the disclosure. FIG. 6 is explained in conjunction with elements from FIG. 1, FIG. 2, FIG. 3A, FIG. 3B, FIG. 4 and FIG. 5. With reference to FIG. 6, there is shown an exemplary scenario 600 that illustrates generation of a set of specular maps 602 to 612 associated with the generation of a roughness map 614. The exemplary set of specular maps 602 to 612 or the roughness map 614 may be generated by any computing system, for example, by the electronic device 102 of FIG. 1 or by the circuitry 202 of FIG. 2.

In an embodiment, the circuitry 202 may be configured to generate the set of specular maps 602-612 of the object (such as, the actor 118) in the UV texture space (such as, the UV texture space 310A associated with the set of texture maps 310B), based on the generated 3D mesh (as shown, for example, in FIG. 3A). The generation of the set of specular maps lⁱ_{specular} may further be based on the first intensity of parallel polarization lighting (Iₚⁱ) and the second intensity of cross-polarization lighting (I_{c}ⁱ). Typically, for set of specular maps generation, specular components may be separated directly from input images (e.g., from the second intensity of cross-polarization lighting pattern (I_{c}i) and the first intensity of parallel polarization lighting pattern (Iₚi)) to generate view dependent specular components for every camera view. Details of such methods have been omitted from the disclosure for the sake of brevity.

In an embodiment, the roughness map 614 may be generated. The circuitry 202 may be configured to generate the roughness map 614 associated with the object in the UV texture space (such as, the UV texture space 310A), based on the generated set of specular maps 602-612, the normal map (for example, the normal map 312A), the set of texture maps 310B of the object, and the set of diffuse maps (for example, the set of diffuse maps 312B). The circuitry 202 may be configured to apply the light model on the generated set of specular maps 602-612 to estimate specular exponent parameters. Alternatively, the roughness map 614 associated with the object may further be generated based on the estimated specular exponent parameters. For example, the electronic device 102 may generate the roughness map 614 based on the application of a Blinn-Phong lighting model to the set of specular maps 602-614, the normal map (for example, the normal map 312A), the set of texture maps 310B of the object, and the set of diffuse maps (for example, the set of diffuse maps 312B) that may estimate the specular exponent parameters. The specular exponent parameters of each image point may be converted to the roughness values. Thus, the roughness map 614 may be generated.

In an embodiment, the normal map (for example, the normal map 312A) may be generated based on the conversion of a surface normal vector associated with the captured set of images 112 of the object (such as, the actor 118). The generated normal map 312A may be associated to a surface and may be independent of geometry of the object.

In an embodiment, the set of texture maps 310B may be generated in the UV space based on the set of motion-corrected images and the 3D mesh. Details of such methods to generate the set of texture maps 310B have been omitted from the disclosure for the sake of brevity.

In an embodiment, the set of diffuse maps may be obtained based on the separation of diffuse components from the UV texture space (such as UV texture space 310A associated with the set of texture maps 310B). The diffuse reflectance components may be separated from each of the set of texture maps, i.e., the cross-polarized lighting pattern in the UV texture space (such as, the UV texture space 310A) and the polarized lighting pattern in the UV texture space (such as, the UV texture space 310A).

It should be noted that the scenario 600 of FIG. 6 is for exemplary purposes and should not be construed to limit the scope of the disclosure.

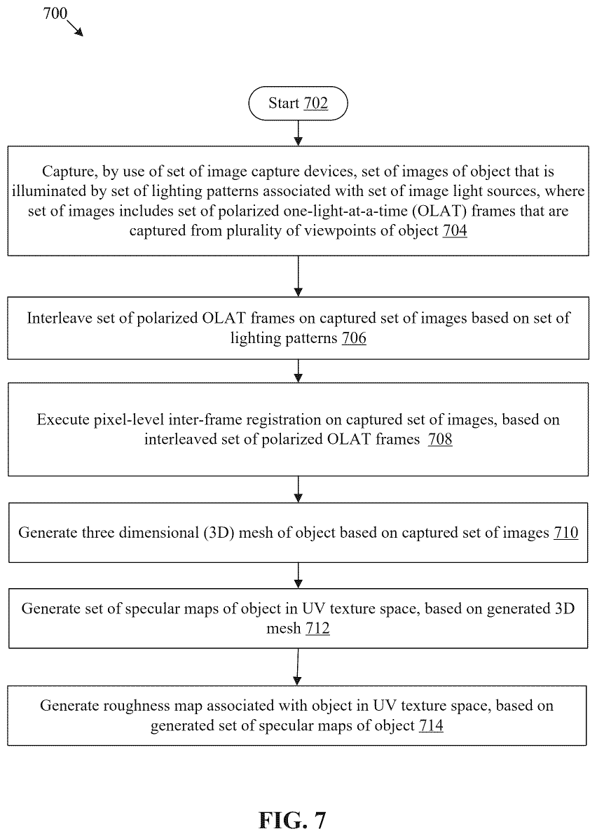

FIG. 7 is a diagram that illustrates a flowchart of an exemplary method for generation of roughness maps for 3D objects, in accordance with an embodiment of the disclosure. FIG. 7 is described in conjunction with elements from FIG. 1, FIG. 2, FIG. 3A, FIG. 3B, FIG. 4, FIG. 5 and FIG. 6. With reference to FIG. 7, there is shown a flowchart 700. The flowchart 700 may include operations from 702 to 714 and may be implemented by the electronic device 102 of FIG. 1 or by the circuitry 202 of FIG. 2. The flowchart 700 may start at 702 and proceed to 704.

At 704, the set of images 112 that may be illuminated by the set of lighting patterns associated with the set of image light sources may be captured by use of the plurality of image-capture devices 116, where the set of images 112 may include the set of polarized one-light-at-a time (OLAT) frames that may be captured from the plurality of viewpoints of the object (e.g., the actor 118). The circuitry 202 may be configured to capture, by use of the plurality of image-capture devices 116, the set of images 112 of the object (e.g., the actor 118) that may be illuminated by the set of lighting patterns associated with the set of image light sources. The set of images 112 may include the set of polarized OLAT frames 402A-408B that may be captured from the plurality of viewpoints of the object. Details related to capture of the set of images are provided, for example, in FIG. 3A (at 302).

At 706, the set of polarized OLAT frames 402A-408B may be interleaved on the captured set of images 112, based on set of lighting patterns. The circuitry 202 may be configured to interleave the set of polarized OLAT frames 402A-408B on the captured set of images 112 based on the set of lighting patterns. Details related to the polarized OLAT frames 402A-408B interleave are provided, for example, in FIG. 3A (at 304) and FIG. 4.

At 708, the pixel-level inter-frame registration may be executed on the captured set of images 112, based on the interleaved set of polarized OLAT frames. The circuitry 202 may be configured to execute the pixel-level inter-frame registration on the captured set of images 112, based on the interleaved set of polarized OLAT frames. Details related to pixel-level inter-frame registration are provided, for example, in FIG. 3A (at 306) and FIG. 4.

At 710, the 3D mesh of the object (e.g., the actor 118) may be generated based on the captured set of images 112. The circuitry 202 may be configured to generate the 3D mesh 308A of the object based on the captured set of images 112. Details related to generation of the 3D map are further provided, for example, in FIG. 3A (at 308).

At 712, the set of specular maps 602-612 of the object (e.g., the actor 118) may be generated in the UV texture space, based on the generated 3D mesh. The circuitry 202 may be configured to generate the set of specular maps 602-612 of the object in the UV texture space, based on the generated 3D mesh. Details related to generation of the specular maps are provided, for example, in FIG. 3B (at 310).

At 714, the roughness map 614 associated with the object (e.g., the actor 118) may be generated in the UV texture space, based on the generated set of specular maps. The circuitry 202 may be configured to generate the roughness map 614 associated with the object in the UV texture space, based on the generated set of specular maps 602-612 of the object. Details related to generation of the roughness map are provided, for example, in FIG. 3B (at 312). Control may pass to end.

Although the flowchart 700 is illustrated as discrete operations, such as, 704, 706, 708, 710, 712, and 714, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include capture of, by use of a plurality of image-capture devices, a set of images of an object that is illuminated by a set of lighting patterns associated with a set of image light sources. The set of images may include a set of polarized one-light-at-a-time (OLAT) frames that may be captured from a plurality of viewpoints of the object. The operations may further include interleaving the set of polarized OLAT frames on the captured set of images based on the set of lighting patterns. The operations may further include execution of a pixel-level inter-frame registration on the captured set of images, based on the interleaved set of polarized OLAT frames. The operations may further include generation of a three-dimensional (3D) mesh of the object based on the captured set of images. The operations may further include generation of a set of specular maps of the object in a UV texture space, based on the generated 3D mesh. The operation may further include generation of a roughness map associated with the object in the UV texture space, based on the generated set of specular maps of the object.

Exemplary aspects of the disclosure may provide an electronic device (such as, the electronic device 102 of FIG. 1) that includes circuitry (such as, the circuitry 202). The circuitry 202 may be configured to capture, by use of a plurality of image-capture devices, a set of images of an object that is illuminated by a set of lighting patterns associated with a set of image light sources. Herein, the set of images may include a set of polarized one-light-at-a-time (OLAT) frames that may be captured from a plurality of viewpoints of the object. The circuitry 202 may be configured to interleave the set of polarized OLAT frames on the captured set of images based on the set of lighting patterns. The circuitry 202 may be configured to execute a pixel-level inter-frame registration on the captured set of images, based on the interleaved set of polarized OLAT frames. The circuitry 202 may be configured to generate a three-dimensional (3D) mesh of the object based on the captured set of images. The circuitry 202 may be configured to generate a set of specular maps of the object in a UV texture space, based on the generated 3D mesh. The circuitry 202 may be configured to generate a roughness map associated with the object in the UV texture space, based on the generated set of specular maps of the object.

In an embodiment, the plurality of image-capture devices may correspond to an imaging setup configured as a polarization-based light cage.

In an embodiment, the set of lighting patterns may be generated in the polarization-based light cage and include at least one of a cross-polarized omni-directional lighting pattern and gradient lighting patterns, or polarized lighting patterns including a cross-polarized lighting pattern and a parallel-polarized lighting pattern.

In an embodiment, the circuitry 202 may be configured to obtain a set of specular-separated gradient images based on a removal of a diffuse component from each first image of the set of images, the first image being associated with the gradient lighting patterns.

In an embodiment, the circuitry 202 may be configured to obtain the set of polarized OLAT frames based on the cross-polarized lighting pattern and parallel-polarized lighting pattern.

In an embodiment, the circuitry 202 may be configured to obtain the cross-polarized lighting pattern and parallel-polarized lighting pattern based on a polarizer installed on a polarization-based light cage associated with the plurality of image-capture devices.

In an embodiment, the circuitry 202 may be configured to register a plurality of pixels of a set of neighboring inter-frames based on the interleaved set of polarized OLAT frames in gradient light patterns and determine a pattern of the registered plurality of pixels based on an interpolation of the set of neighboring inter-frames.

In an embodiment, the circuitry 202 may be configured to determine a sparse feature point between the set of images from the plurality of viewpoints determine a plurality of camera parameters associated with the plurality of image-capture devices; and determine a relationship between each image point of an image of the set of images, with each corresponding 3D point associated with the 3D mesh based on the determined plurality of camera parameters. Herein, the relationship is determined for each viewpoint of the plurality of viewpoints, and the execution of the pixel-level inter-frame registration is further based on the determined relationship of each image point with each corresponding the 3D point associated with the 3D mesh.

In an embodiment, the circuitry 202 may be configured to determine a location of the plurality of image-capture devices and the set of image light sources associated with the set of lighting patterns determine, based on the determined location, a coverage of an imaging setup associated with the plurality of image-capture devices and the set of image light sources and determine a light intensity captured in the set of images based on the generated 3D mesh and determined coverage.

In an embodiment, the circuitry 202 may be configured to apply a lighting model on the captured set of images determine a light intensity of each OLAT frame of the set of polarized OLAT frames based on the application of the lighting model on the captured set of images and fine-tune a lighting direction of the set of image light sources.

In an embodiment, the lighting model may include at least one of a Lambertian lighting model, a Phong illumination model, a Blinn-Phong illumination model, or Smallpt lighting model.

In an embodiment, the generation of the set of specular maps may be further based on a first intensity of parallel polarization lighting and a second intensity of a cross-polarization lighting.

In an embodiment, the circuitry 202 may be configured to apply a light model on the generated set of specular maps and estimate specular exponent parameters based on the application of the lighting model on the generated specular maps. Herein, the generation of the roughness map associated with the object is further based on the estimation of the specular exponent parameters.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
capture, by use of a plurality of image-capture devices, a set of images of an object that is illuminated by a set of lighting patterns associated with a set of image light sources, wherein
the set of images includes a set of polarized one-light-at-a-time (OLAT) frames that are captured from a plurality of viewpoints of the object;
interleave the set of polarized OLAT frames on the captured set of images based on the set of lighting patterns;
execute a pixel-level inter-frame registration on the captured set of images, based on the interleaved set of polarized OLAT frames;
generate a three-dimensional (3D) mesh of the object based on the captured set of images;
generate a set of specular maps of the object in a UV texture space, based on the generated 3D mesh; and
generate a roughness map associated with the object in the UV texture space, based on the generated set of specular maps of the object.

2. The electronic device according to claim 1, wherein the plurality of image-capture devices corresponds to an imaging setup configured as a polarization-based light cage.

3. The electronic device according to claim 2, wherein the set of lighting patterns are generated in the polarization-based light cage and include at least one of:
a cross-polarized omni-directional lighting pattern and gradient lighting patterns, or
polarized lighting patterns including a cross-polarized lighting pattern and a parallel-polarized lighting pattern.

4. The electronic device according to claim 3, wherein the circuitry is further configured to obtain a set of specular-separated gradient images based on a removal of a diffuse component from each first image of the set of images, the first image being associated with the gradient lighting patterns.

5. The electronic device according to claim 3, wherein the circuitry is further configured to obtain the set of polarized OLAT frames based on the cross-polarized lighting pattern and parallel-polarized lighting pattern.

6. The electronic device according to claim 3, wherein the circuitry is further configured to obtain the cross-polarized lighting pattern and parallel-polarized lighting pattern based on a polarizer installed on a polarization-based light cage associated with the plurality of image-capture devices.

7. The electronic device according to claim 1, wherein the circuitry is further configured to:
register a plurality of pixels of a set of neighboring inter-frames based on the interleaved set of polarized OLAT frames in gradient light patterns; and
determine a pattern of the registered plurality of pixels based on an interpolation of the set of neighboring inter-frames.

8. The electronic device according to claim 1, wherein the circuitry is further configured to:
determine a sparse feature point between the set of images from the plurality of viewpoints;
determine a plurality of camera parameters associated with the plurality of image-capture devices; and
determine a relationship between each image point of an image of the set of images, with each corresponding 3D point associated with the 3D mesh based on the determined plurality of camera parameters, wherein
the relationship is determined for each viewpoint of the plurality of viewpoints, and
the execution of the pixel-level inter-frame registration is further based on the determined relationship of each image point with each corresponding the 3D point associated with the 3D mesh.

9. The electronic device according to claim 1, wherein the circuitry is further configured to:
determine a location of the plurality of image-capture devices and the set of image light sources associated with the set of lighting patterns;
determine, based on the determined location, a coverage of an imaging setup associated with the plurality of image-capture devices and the set of image light sources; and
determine a light intensity captured in the set of images based on the generated 3D mesh and determined coverage.

10. The electronic device according to claim 1, wherein the circuitry is further configured to:
apply a lighting model on the captured set of images;
determine a light intensity of each OLAT frame of the set of polarized OLAT frames based on the application of the lighting model on the captured set of images; and
fine-tune a lighting direction of the set of image light sources.

11. The electronic device according to claim 10, wherein the lighting model may include at least one of a Lambertian lighting model, a Phong illumination model, a Blinn-Phong illumination model, or Smallpt lighting model.

12. The electronic device according to claim 1, wherein the generation of the set of specular maps is further based on a first intensity of parallel polarization lighting and a second intensity of a cross-polarization lighting.

13. The electronic device according to claim 1, wherein the circuitry is further configured to:
apply a light model on the generated set of specular maps; and
estimate specular exponent parameters based on the application of the lighting model on the generated set of specular maps, wherein
the generation of the roughness map associated with the object is further based on the estimation of the specular exponent parameters.

14. A method, comprising:
in an electronic device:
capturing, by use of a plurality of image-capture devices, a set of images of an object that is illuminated by a set of lighting patterns associated with a set of image light sources, wherein
the set of images includes a set of polarized one-light-at-a-time (OLAT) frames that are captured from a plurality of viewpoints of the object;
interleaving the set of polarized OLAT frames on the captured set of images based on the set of lighting patterns;
executing a pixel-level inter-frame registration on the captured set of images, based on the interleaved set of polarized OLAT frames;
generating a three-dimensional (3D) mesh of the object based on the captured set of images;
generating a set of specular maps of the object in a UV texture space, based on the generated 3D mesh; and
generating a roughness map associated with the object in the UV texture space, based on the generated set of specular maps of the object.

15. The method according to claim 14, wherein the plurality of image-capture devices corresponds to an imaging setup configured as a polarization-based light cage.

16. The method according to claim 15, wherein the set of lighting patterns are generated in the polarization-based light cage and include at least one of:
a cross-polarized omni-directional lighting pattern and gradient lighting patterns, or
polarized lighting patterns including a cross-polarized lighting pattern and a parallel-polarized lighting pattern.

17. The method according to claim 16, further comprising obtaining a set of specular-separated gradient images based on a removal of a diffuse component from each first image of the set of images, the first image being associated with the gradient lighting patterns.

18. The method according to claim 16, further comprising obtaining the set of polarized OLAT frames based on the cross-polarized lighting pattern and parallel-polarized lighting pattern.

19. The method according to claim 16, further comprising obtaining the cross-polarized lighting pattern and parallel-polarized lighting pattern based on a polarizer installed on a polarization-based light cage associated with the plurality of image-capture devices.

20. A non-transitory computer-readable medium having stored thereon, computer-executable instructions that when executed by an electronic device, causes the electronic device to execute operations, the operations comprising:
capturing, by use of a plurality of image-capture devices, a set of images of an object that is illuminated by a set of lighting patterns associated with a set of image light sources, wherein
the set of images includes a set of polarized one-light-at-a-time (OLAT) frames that are captured from a plurality of viewpoints of the object;
interleaving the set of polarized OLAT frames on the captured set of images based on the set of lighting patterns;
executing a pixel-level inter-frame registration on the captured set of images, based on the interleaved set of polarized OLAT frames;
generating a three-dimensional (3D) mesh of the object based on the captured set of images;
generating a set of specular maps of the object in a UV texture space, based on the generated 3D mesh; and
generating a roughness map associated with the object in the UV texture space, based on the generated set of specular maps of the object.
